(19) United States
(12) Patent Application Publication
(10) Pub. No.: US 2007/0101093 A1
(43) Pub. Date: May 3, 2007

(54) Method of providing history and compliance information for objects

(75) Inventor: Richard Anthony Lawrence, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/495,618

(22) Filed: Jul. 31, 2006

(30) Foreign Application Priority Data
Oct. 28, 2005 (GB) 0521979.5

(51) Int. Cl. G06F 12/00

(52) U.S. Cl. 711/170

(57) ABSTRACT

A method of maintaining a data record for an object, the method comprising associating a memory tag with an object, the memory tag being arranged to store data relating to the object; and writing data to the memory tag subsequent to associating the memory tag with the object and at subsequent times thereafter, wherein the stored data comprises a historical record of the object.

In many situations it is desirable to know details of a physical object, particularly an item of apparatus or an individual component within a more complex apparatus. This may be information such as the composition of the apparatus, a service history of the component or apparatus, certification to comply with a particular standard and a record of the usage of the apparatus or components, either solely in terms of the number of times or duration the apparatus has been used for or in terms of the type of usage the component or apparatus has been subjected to or a combination of both. This list is not exhaustive or exclusive and other data relating to the component or apparatus may be desirable to know and maintain a record of.

In the past the compilation and maintenance of such details associated with an apparatus or component was performed manually using paper records. Not only did this involve a considerable amount of time in recording the details for a component or apparatus, but more importantly required a large amount of physical records to be stored. The amount of physical storage required was at best an inconvenience and at worst prohibited the collection of comprehensive details associated with an apparatus or component because the sheer physical volume of data storage required tended to inhibit the comprehensive collection of data, together with issues regarding the duration that data could be stored, both in terms of the physical space required for long term storage and also existence of problems with keeping the physical records in a usable condition over a long time period. A further disadvantage of the use of physical records was that a correlation between the apparatus or component and record had to exist, since the records were physically separated from the apparatus or component. The use of serial numbers and part codes and the like introduced the possibility of incorrect association of an apparatus or component with the wrong record, usually due to human error in the initial data entry stage. Although the advent of electronic data capture and storage has greatly reduced the physical space required to maintain such component or apparatus history, it has introduced further problems associated with the rapid development and change of the technology used both for the data capture and maintenance and also the technology associated with the data storage medium itself. This can lead to problems of updated data systems being unable to either physically read or write data from older storage media or there being an incompatibility between the data types or formats of the historical stored data and those data types and formats used by newer systems. A further disadvantage of both manual and electronic data storage systems in which the data is stored separately from the apparatus or component in question is that the integrity of the data itself is more difficult to ensure. For example, a separate data entry and storage system, even if using encrypted data and or password protection will always remain vulnerable to the system being either attacked by an unauthorised user, known as hackers, or will be vulnerable to an authorised user performing actions for the benefit of other, non-authorised individuals.

A first aspect of the present invention therefore provides a method of maintaining a data record for an object, the method comprising associating a memory tag with the object, the memory tag being arranged to store data relating to the object, and writing data to the memory tag relating to the object subsequent to associating the memory tag with the object and at subsequent times thereafter, wherein the stored data comprises a historical record of the object.

The historical record preferably comprises one or more of the service history of the object, a compliance record of the object of at least one standard and a usage history of the object. This list, as will be appreciated by those skilled in the art, is intended to be neither exclusive nor exhaustive, however the characterising feature of the historical record is that a history of the object over its entire life time is built up and maintained.

A second aspect of the present invention provides a data recordal system for maintaining a data record of an object comprising a memory tag associated with an object and arranged to store data relating to the object; and a writing device arranged to write data relating to the object to the memory tag subsequent to the memory tag being associated with the object, whereby the stored data comprises a historical record of the object.

Embodiments of the present invention will now be described, by way of non limiting illustrative example only, with reference to the accompanying figures, of which:

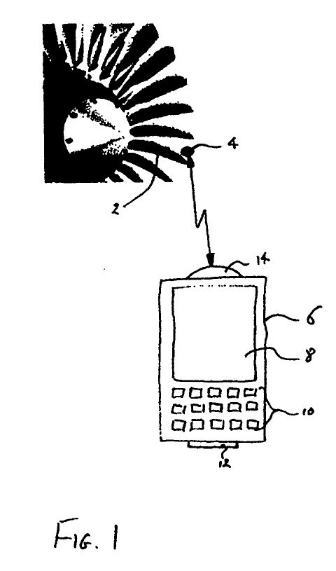

FIG. 1 schematically illustrates a memory spot fixed to a component and a hand-held read/write device in accordance with embodiments of the present invention;

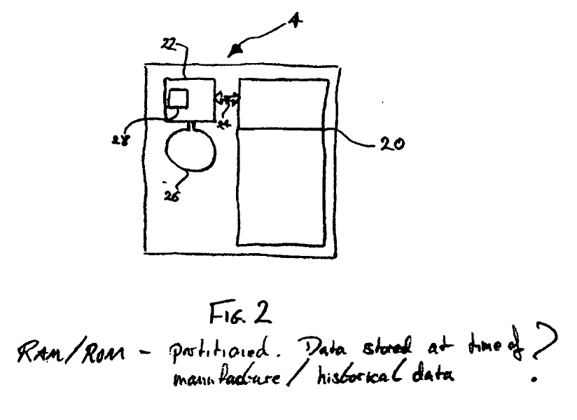

FIG. 2 schematically illustrates the physical configuration of a memory spot for use in embodiments with the present invention;

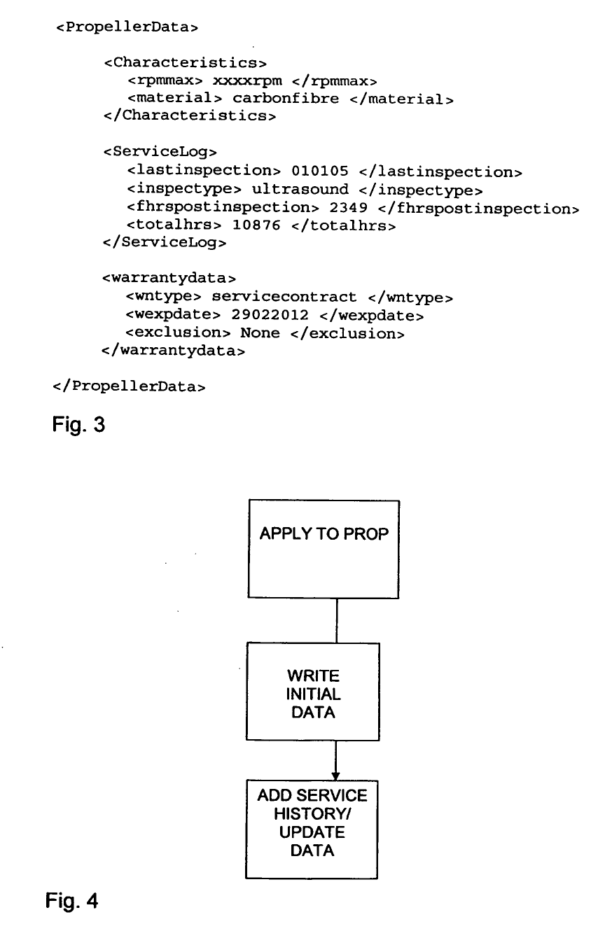

FIG. 3 illustrates an example of the data content of a memory spot in accordance with an embodiment of the present invention; and

FIG. 4 schematically illustrates the methodology of the present invention.

FIG. 1 schematically illustrates a component to which a memory spot 4 is associated. In the particular example illustrated in FIG. 1 the component 2 is an individual propeller blade that forms part of an aero engine. However, it will be appreciated that the propeller blade is illustrated simply as an example and that the memory spot 4 may be associated with any desired apparatus or component. Shown in communication with the memory spot 4 is a hand-held read/write device 6. In a typical example the read/write device may comprise a pocket PC or hand-held computer, such as those manufactured by the applicant under the trade name IPAQ™. However, the hand-held read/write device may equally be a custom device. The read/write device 6 typically includes a display screen 8 that may be used to display information read from the memory spot as well as, or alternatively, displaying data to be written to the memory spot 4. The read/write device 6 may preferably also include an input device, which in the example illustrated in FIG. 1 comprises a keyboard 10. Again, as will be appreciated by those skilled in the art, the input device is not limited to a keyboard and may comprise, for example, a touch sensitive screen, most probably in conjunction with the display screen 8. The read/write device 6 preferably also includes a connector 12 to enable the read/write device to be connected to an additional computing system such that data held by the read/write device may be communicated to the additional computer system, and equally or alternatively, data to be written to the memory spot 4 may be communicated to the read/write device by the additional computer system. Once again it will be appreciated by those skilled in the art, the connector 12 may be substituted for any other known communication means, for example a wireless or infrared transceiver. Communication between the read/write device 6 and the memory spot 4 is accomplished preferably also by means of a wireless connection. Consequently, the read/write device 6 is provided with a suitable wireless transceiver 14. The wireless transceiver preferably comprises an inductive antenna, that in use is intended to be brought into close physical proximity with the memory spot 4 to enable wireless communication to be effected between the memory spot 4 and the read/write device 6.

The memory spot 4 is preferably fixed to the propeller blade 2 in an irreversible manner. For example, the memory spot 4 may be adhered to the propeller blade using a suitable permanent adhesive. However, it is more preferable for the memory spot to be fixed to the propeller blade in an irreversible manner during the manufacture of the propeller blade. For example, the memory spot may be affixed to the propeller blade, for example using a suitable adhesive, and subsequently covered by an appropriate final layer of coating material that is applied to the entirety of the propeller blade. In this example, the coating layer, which may for example comprise of a resin or lacquer coating, must not be too thick to prevent the memory spot 4 from being able to communicate wirelessly with the read/write device 6. The advantage of incorporating the memory spot 4 within the component at the time of manufacture or permanently adhering the memory spot to the component is that there is no possibility of the memory spot 4 becoming disassociated with the component. Therefore, there is absolute confidence by a user that the data held by the memory spot relates to only the component to which it is affixed. This is important in preventing the incorrect association of historical data with the wrong component, as is possible with prior art systems that rely on the cross-referencing of a component identity number, for example, and a separately stored record or history. It is also ensures that a false record cannot be maliciously affixed to a component subsequent to the component manufacture, thereby preventing the use or sale of counterfeit or falsely accredited components.

FIG. 2 schematically illustrates the internal components of a memory spot suitable for use in embodiments of the present invention. The memory spot 4 comprises a memory 20, which is in communication with an internal data processor 22. The data processor 22 and memory 20 communicate by means of a data bus 24 in the manner known to the skilled person. Also in communication with the data processor 22 is an inductive antenna 26. In use, the antenna 26 is inductively coupled to a corresponding antenna on an appropriate read/write device, such as that shown in FIG. 1. Power is inductively coupled from the read/write device to the memory spot 4, thus enabling the data processor 22 to control the exchange of data between the memory spot memory 20 and the read/write device. In some embodiments of the present invention the data processor 22 may include an encryption engine 28. The function of the encryption engine 28 is to encrypt data received from the read/write device prior to storing the data in the memory spot memory 20 and to. The encryption/decryption process is controlled using, for example, a personal/private key system in conjunction with the read/write device, such that only a read/write device having the appropriate encryption key can either access data stored on the memory spot or write further data to the memory spot. As will be appreciated by those skilled in the art, the encryption engine 28 may in fact be implemented simply as one of the many functions executed by the data processor 22, rather than existing as a discrete processing entity. It will also be appreciated that the encryption and decryption process may take place solely on the read/write device. The use of encryption further ensures the integrity of the data history of the component stored on the memory spot and further reduces the possibility of false data being stored on the memory spot, or data being accessed from the memory spot, by unauthorised personnel. The integrity of the stored data may also be maintained by arranging for the data processor 22 to prohibit data that has been stored on the memory 20 from being either deleted or amended. Alternatively, the memory 20 may be such that it is physically impossible for data stored on the memory to be either deleted or amended. For example, the memory 20 may comprise Programmable Read Only Memory (PROM).

A method of compiling and maintaining a historical data record associated with a component or apparatus is now described with reference to the particular example illustrated in FIG. 1. At the time of manufacture of the propeller blade a memory spot is irreversibly associated with a propeller blade, as previously discussed. Certain items of data are then preferably written to the memory spot, either immediately subsequent to manufacture, prior to final installation of the propeller blade, or immediately after installation of the propeller blade. These items of data are referred to as “primary data” and include data items whose values are static, in other words that will not change over time or usage. FIG. 3 provides a schematic illustration of the presentation of the primary data for the propeller blade of FIG. 1 as that data may appear on the screen 8 of a read-write device 6. In the example referred to, the primary data comprises item identification, date of manufacture, composition of both the propeller blade and blade root, the maximum RPM to which the propeller blade can be subjected, the stipulated inspection period for the propeller blade, both visual and non-destructive testing inspection and finally the total service life of the propeller blade as stipulated by the manufacturer. In the example illustrated in FIG. 3, the primary data is written in an unencrypted or encoded format so as to be directly readable. Data which relates to sensitive subject-matter may, however be written in encrypted form. In further embodiments the primary data may be written to the memory spot utilising a coding system for the different data items, the benefit of this being that the memory requirements for the memory spot is minimised. However, the advantage of storing the data in conventional ASCII format is that the data is easily readable by all users. In one preferred modification, the data is provided with a structure which is interpretable by a computer. One example is by embedding ‘tags’ written in Extensible Markup Language within the data, each of which performs the function of ‘marking’ a certain section of the data, for example, as relating to a particular subject. Thus, in the example of the propeller blade, there could be an XML tag which bounds the text relating to RPMMax as follows:
<rmpMax>XXXXXrpm</rpmMax>

This is capable of interpretation by a suitably configured XML parser, which may thus retrieve and display that section of the data which relates to the maximum RPM. Typically this will take place within the reading device.

Subsequent to the propeller blade passing out of the control of the manufacturer, i.e. either being installed in a particular aeroplane or simply being provided to an appropriate supplier, further data may be written to the memory spot, using a suitable read-write device at repeated intervals thereafter. Also illustrated in FIG. 3 is an example of such further data, stored in a service log. The further data comprises the date on which an inspection is conducted, the initials of the engineer completing that inspection, the number of elapsed flying hours since the previous inspection, the total number of elapsed flying hours for which the propeller blade has been used, the type of inspection conducted, i.e. visual or NDT, and any further comments. This data may be provided in tabular form but in the example shown in FIG. 3, is an XML document. The data is readily available at any point that the memory spot is read by a read-write device. Consequently, a life-time history of the propeller blade is generated and maintained in a convenient manner, the historical record being capable of demonstrating that the propeller blade has been inspected in compliance with the stipulated inspection periods.

The summary of the method is schematically illustrated in FIG. 4, with step I being the initial association of the memory spot with the component, the subsequent step being the writing of the primary data to the memory spot and the final step being the repeated process of adding service history regarding the component to the memory spot.

Further examples of data which might usefully be included in a preferred embodiment is data relating to warranty information. Thus, data which manifests whether the propeller blade is under warranty cover, the nature of the warranty, its date of expiry and any special terms or exclusions which might apply may all be included.

Amongst the advantages of this method are the ease of use of the memory spot and associated read-write device such that no specialist training is required to either record or retrieve the historical record and also that the memory spot is permanently fixed to the component or apparatus in question during its life time, such that the historical record itself is also permanently associated with the component or apparatus. This tends to promote more accurate and complete data recordal, since the appropriate end-user can complete data writing process at the same time as conducting the test on inspection of the component or apparatus, rather than perform the updating process separately from the test or inspection. Thus, because the data record is intimately associated with the component or apparatus itself, the possibilities for substituting a false record for a component are significantly reduced.

1. A method of maintaining a data record for an object, the method comprising:
associating a memory tag with an object, the memory tag being arranged to store data relating to the object; and
writing data to the memory tag subsequent to associating the memory tag with the object and at subsequent times thereafter, wherein the stored data comprises a historical record of the object.

2. A method according to claim 1, wherein the historical record includes at least one of a service history of the object, a usage history of the object and a compliance record of the object with at least one standard.

3. A method according to claim 1, wherein the writing step comprises encrypting the data to be written to the memory tag.

4. A method according to claim 1, wherein the data stored on the memory tag is protected from being subsequently amended or deleted.

5. A method according to claim 1, wherein user authorisation is required before data can be written to and/or read from the memory tag.

6. A method according to claim 1, wherein the memory tag is irreversibly associated with the object.

7. A method according to claim 5, wherein the memory tag is incorporated into the object at the time of manufacture of the object.

8. A method according to claim 1, wherein data is read from and/or written to the memory device wirelessly.

9. A method according to claim 1, wherein the memory tag comprises an inductively activated memory spot.

10. A method according to claim 1, wherein the data stored on the memory tag comprises coded data items, whereby a coded data item is representative of further information.

11. A data recordal system for maintaining a data record of an object comprising:
a memory tag associated with an object and arranged to store data relating to the object; and
a writing device arranged to write data relating to the object to the memory tag subsequent to the memory tag being associated with the object, whereby the stored data comprises a historical record of the object.

12. A data recordal system according to claim 11, wherein the historical record includes at least one of a service history of the object, a usage history of the object and a compliance record of the object with at least one standard.

13. A data recordal system according to claim 11, wherein the data writing device is arranged to encrypt the data to written to the memory tag.

14. A data recordal system according to claim 11, wherein the memory tag is arranged to encrypt the data written to the memory tag.

15. A data recordal system according to claim 11, wherein the memory tag is arranged to inhibit previously stored data being amended and/or deleted.

16. A data recordal system according to claim 11, wherein the memory tag is arranged to only permit data to be written to and/or read from the memory tag on receipt of a user authorisation.

17. A data recordal system according to claim 11, wherein the data writing device is arranged to only permit data to be written to the memory tag on receipt of a user authorisation.

18. A data recordal system according to claim 11, wherein the memory tag is arranged to communicate with the data writing device wirelessly.

19. A data recordal system according to claim 18, wherein the memory tag comprises an inductively coupled memory spot
